(19) United States
(12) Patent Application Publication
(10) Pub. No.: US 2026/0330209 A1
(43) Pub. Date: Oct. 22, 2026

(54) TEMPORAL-AWARE TOKEN PERSISTENCE FOR VISUAL TOKEN REDUCTION IN PHYSICAL ARTIFICIAL INTELLIGENCE (AI)

(71) Applicant: Dorian Cartwright, San Jose, CA (US)

(72) Inventor: Dorian Cartwright, San Jose, CA (US)

(21) Appl. No.: 19/572,246

(22) Filed: Mar. 19, 2026

(51) Int. Cl. G06N 3/063; G06F 40/284

(52) U.S. Cl. CPC G06N 3/063; G06F 40/284

(57) ABSTRACT

Temporal-aware token persistence in embodied artificial intelligence architectures improves degraded performance caused by token budgets. A sequence of visual frames is processed to generate visual tokens. A subset of the visual tokens associated with a physical object, region, or environmental condition is used to generate a skeleton token set comprising a reduced persistent representation. The skeleton token set is assigned a temporal lock for a temporal interval spanning multiple subsequent frames. During the temporal interval, a token pruning algorithm removes lower-priority tokens under a token budget, while one or more tokens corresponding to the skeleton token set are exempted from the token pruning algorithm irrespective of an instantaneous salience metric. The retained skeleton token set preserves decision-relevant information for downstream perception, prediction, planning, or control in an embodied artificial intelligence system.

### FIELD OF THE INVENTION

The present invention relates generally to computer systems and machine learning and, more specifically, to temporal-aware token persistence during token reduction in physical artificial intelligence (AI).

### BACKGROUND

Embodied AI systems increasingly process continuous streams of visual or multimodal sensor data using token-based neural architectures. In many implementations, sensor data is encoded into visual tokens, latent tokens, patch tokens, object tokens, or other discrete representational units that are processed by transformer-based or related models to perform perception, prediction, planning, and control. Because these systems often operate under tight latency, power, memory, and compute constraints, token pruning is commonly used to reduce inference cost.

Existing token pruning systems generally evaluate token importance on a frame-by-frame basis. For example, token retention may depend on instantaneous attention score, reconstruction score, motion intensity, novelty, or related salience metrics. Although such approaches can reduce computational overhead by dropping redundant background information, they create a significant safety and reliability problem in physical environments.

A scene element may remain important to downstream planning even when its per-frame salience drops temporarily. For example, a child may pause behind a parked vehicle, a cyclist may become partially occluded, a worker may remain near a hazardous machine while temporarily static, or a forklift may pass behind warehouse shelving. In such situations, frame-local token pruning may delete representations of the object or region because the object no longer appears sufficiently salient in the current frame. As a result, the embodied AI system may effectively forget a decision-relevant object, region, or environmental condition.

Conventional tracking and temporal memory methods do not adequately address this problem in token-pruned embodied AI architectures. Existing systems may track object identities or maintain generic temporal state, but they do not provide a compute-governed mechanism for protecting a reduced token subset from ordinary pruning rules over a defined temporal interval.

Accordingly, there is a need for robust techniques that preserve a bounded persistent token representation for safety-relevant or decision-relevant entities under token budget constraints, even when instantaneous salience decreases.

### SUMMARY

The aforementioned shortcomings are addressed by the present disclosure in providing systems, methods, and non-transitory computer-readable media for temporal-aware token persistence in embodied AI systems. To address a memory gap in token-pruned embodied AI systems, rather than relying exclusively on frame-level salience to decide token retention, the disclosed system identifies a reduced persistent token representation for a physical object, region, or environmental condition and protects that representation from ordinary pruning for a temporal interval.

In one aspect, the system receives a sequence of visual frames or other sensor observations and generates tokenized representations for respective time steps. A subset of tokens associated with a physical object, region, or environmental condition is selected and transformed into a reduced persistent representation referred to herein as a Skeleton Token Set. The Skeleton Token Set is assigned a temporal lock or a temporal persistence state, such as a temporal lock, for a temporal interval spanning multiple subsequent frames.

During the temporal interval, a token pruning algorithm continues to prune non-persistent tokens under a token budget, but one or more tokens corresponding to the Skeleton Token Set are exempted from ordinary pruning rules. In this way, the system retains a protected persistent representation even when the corresponding object, region, or environmental condition experiences a drop in instantaneous salience due to occlusion, temporary static behavior, reduced motion, background blending, or similar conditions.

In some embodiments, the persistent representation is maintained in a persistent token memory, a KV cache, a world-model memory, or another retained token store. In some embodiments, the system reserves a portion of the token budget for one or more Skeleton Token Sets. In some embodiments, persistent tokens are refreshed, compressed, decayed, or released according to planner feedback, hazard scoring, occlusion state, predicted re-emergence, confidence metrics, or policy rules.

The disclosed approach improves temporal continuity, object permanence, hazard awareness, and control reliability in embodied AI systems while preserving the efficiency benefits of aggressive token pruning.

### BRIEF DESCRIPTION OF FIGURES

The accompanying drawings, which are incorporated in and constitute a part of this specification, illustrate exemplary embodiments of the present invention and, together with the detailed description, serve to explain the principles, features, and operation of the disclosed subject matter. Like reference numerals generally refer to like elements throughout the drawings.

FIG. 1 is a block diagram of a physical AI for protected bypass of a pruning algorithm for tokens corresponding to a persistent Skeleton Token Set, according to an embodiment.

FIG. 2 is a block diagram of temporal token persistence module, according to an embodiment.

FIG. 3 is a diagram illustrating generation of a Skeleton Token Set from a first frame and application of a temporal lock across subsequent frames, according to an embodiment.

FIG. 4 illustrates a high-level method for protected bypass of a pruning algorithm for tokens corresponding to a persistent Skeleton Token Set, according to an embodiment.

FIG. 5 illustrates a more detailed method for pruning tokens from visual frames to reduce token cost, while maintaining skeleton tokens, according to an embodiment

FIG. 6 illustrates a more detailed method for edge inferencing versus data center by token budget, according to an embodiment.

FIG. 7 is a flow diagram illustrating a method for operation under multiple token budget modes, according to an embodiment.

FIG. 8 illustrates an example of a computer device for deploying AI systems described herein, according to an embodiment.

### DETAILED DESCRIPTION

The following description provides methods, systems, and computer program products for identifying a reduced persistent token representation for a physical object, region, or environmental condition and protects that representation from ordinary pruning for a temporal interval.

As used herein, a “token” may include any discrete representation derived from sensor data, including patch tokens, visual tokens, fused multimodal tokens, latent tokens, object-centric tokens, semantic region tokens, point-cloud tokens, radar tokens, or compressed memory units. A “salience metric” refers to any frame-local measure of token importance, including attention score, motion magnitude, reconstruction error, novelty score, entropy, or a learned importance value.

A “Skeleton Token Set” is a reduced persistent representation associated with a physical object, region, or environmental condition. The Skeleton Token Set need not include every token of the source entity. Instead, it may include a minimal subset sufficient to preserve object continuity, hazard relevance, spatial extent, semantic identity, trajectory context, or planner relevance across time.

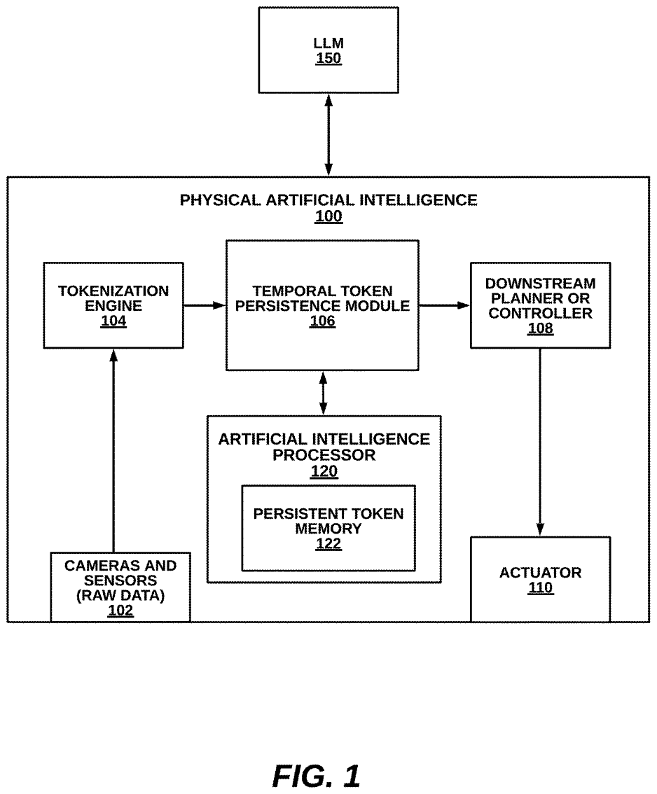

### I. Systems for Temporal-Aware Token Persistence (FIGS. 1-3)

FIG. 1 is a block diagram of a physical AI (an embodied AI system) 100 including cameras and/or sensors 102, a tokenization engine 104, a temporal token persistence module 106, a downstream planner or controller 108, an actuator 110, an artificial intelligence processor 120 with a persistent token memory 122, and a large language module (LLM) 150 according to a non-limiting embodiment.

An embodied AI system may include one or more cameras and optionally lidar, radar, depth, inertial, thermal, or other sensors. Raw data is fed in. The sensor data is processed by the tokenization engine 104, implemented as a visual encoder or multimodal encoder, to generate tokenized representations.

The temporal token persistence module 106 evaluates whether a subset of tokens should be designated as persistent. The module may operate using rule-based logic, learned scoring, planner feedback, world-model state, or combinations thereof. A token pruning module then prunes non-persistent tokens under latency, memory, or compute constraints. Protected persistent tokens are retained in a persistent token memory, which may be implemented as a KV cache, memory cache, token store, world-model memory, or another retained representational structure.

Once one or more visual frames have been appropriately pruned, the large language model 150 located at a remote data center can process and determine next actions. Preferably, the pre-processing is able to reduce LLM costs while maintaining accuracy. Alternatively, a small language model (SLM) can process locally, when within its capabilities, for further reducing large language model costs.

The retained token information is supplied to one or more downstream planner or controllers 108, such as a policy model, trajectory predictor, occupancy model, action decoder, planner, safety controller, or actuator controller. In some embodiments, the system performs automated actions based on tracking of objects, regions, or environmental conditions represented by a Skeleton Token Set while operating under reduced token usage. Because the Skeleton Token Set provides a compact, persistent representation across multiple frames, downstream modules may continue to execute control, safety, and interaction behaviors without requiring full-frame or dense-token processing at each time step. For example, the actuator 110 may automatically adjust speed, braking, steering, path selection, following distance, lane positioning, or trajectory smoothing based on a persisted representation of a pedestrian, vehicle, obstacle, or hazard, even when corresponding full-resolution tokens are pruned. In robotic embodiments, a controller may perform locomotion adjustments, balance corrections, obstacle avoidance, grasp planning, tool manipulation, or workspace reconfiguration using persistent tokens associated with terrain features, contact surfaces, or interaction targets. In aerial or mobile platforms, navigation behaviors such as collision avoidance, geofencing, waypoint adjustment, landing-zone selection, or clearance maintenance may be executed using compact persistent token representations of obstacles, boundaries, or hazards.

In some embodiments, automated actions are triggered or modulated by attributes of the persistent representation, including persistence duration, hazard score, trajectory consistency, proximity, predicted interaction, or uncertainty level. For instance, a high-priority persistent token set may maintain braking or avoidance behavior across multiple frames despite temporary occlusion, while a lower-priority set may be represented in a compressed form sufficient to support continued monitoring without full action commitment. Because the number of retained tokens is reduced relative to full-frame processing, the system can maintain real-time control loops within latency, compute, and energy constraints, including on edge devices, while still preserving continuity of decision-relevant entities. Thus, the disclosed persistence mechanism enables closed-loop automated actions that are robust to token pruning and bounded by available token budgets.

### A. Initialization and Skeleton Token Extraction

At an initial time step T0, the system processes a first frame to generate a plurality of visual tokens. From these tokens, the system identifies a subset associated with a physical object, region, or environmental condition. The selection may be based on one or more of semantic class, vulnerability class, location relative to an ego path, predicted trajectory overlap, hazard proximity, motion history, partial occlusion, planner relevance, uncertainty level, policy rule, or a learned persistence score. The selected subset is transformed into a Skeleton Token Set. In some embodiments, the Skeleton Token Set contains a reduced fraction of the source token cluster, such as 5-20% of the original token count. In some embodiments, the Skeleton Token Set preserves a bounding structure, a semantic core, a trajectory-linked subset, an object anchor pattern, or a compressed latent representation.

After generation, the Skeleton Token Set is assigned a temporal persistence state. In one embodiment, the persistence state comprises a temporal lock that protects corresponding tokens for a temporal interval spanning multiple subsequent frames. The interval may be fixed, such as 30 or 60 frames, or adaptive based on scene risk, predicted re-emergence, route complexity, policy configuration, or planner feedback. Unlike ordinary frame-local pruning systems, the disclosed system does not require the protected tokens to re-earn retention in each subsequent frame based solely on instantaneous salience. Instead, persistence is maintained over time based on the prior designation of the Skeleton Token Set and any applicable update or release conditions.

In various embodiments, the physical object, region, or environmental condition represented by a Skeleton Token Set may correspond not only to discrete objects but also to physical environmental conditions encountered by a humanoid or other embodied agent operating in a real-world environment. Such environmental conditions may include, without limitation, terrain characteristics (e.g., uneven ground, stairs, slopes, loose gravel, mud, wet or slippery surfaces), structural features (e.g., walls, doorways, ceilings, ledges, railings), dynamic obstacles (e.g., moving vehicles, humans, animals, machinery), and ambient or contextual conditions (e.g., lighting variations, shadows, glare, reflections, weather effects, smoke, fog, or particulate matter). Additional conditions may include spatial constraints (e.g., narrow passages, cluttered regions), interaction-relevant features (e.g., graspable objects, support surfaces, seating areas), and hazard-related conditions (e.g., drop-offs, sharp edges, hot surfaces, unstable structures, or regions of high collision risk). In some embodiments, such environmental conditions are not represented as discrete object detections but instead emerge as distributed token patterns, spatial gradients, or latent features within the tokenized representation. The Skeleton Token Set may therefore capture a compact, persistent representation of such conditions, enabling the embodied agent to maintain awareness of terrain, hazards, and interaction affordances across multiple frames, including during periods of partial observability, occlusion, or transient sensor degradation.

In various embodiments, visual data may be captured using one or more imaging devices configured to observe a physical environment over time. Such imaging devices may include, without limitation, monocular cameras, stereo camera systems, depth cameras, RGB-D sensors, infrared cameras, event-based cameras, fisheye or wide-angle cameras, multi-camera arrays, or other optical sensing systems deployed on a vehicle, robot, drone, or fixed infrastructure. The captured visual data may comprise high-resolution video streams, including, for example, 720p, 1080p, 4K, 8K, or higher resolutions, and may be acquired at frame rates such as 24, 30, 60, or greater frames per second. In such configurations, each frame may be tokenized into a large number of visual tokens, such as patch tokens, region tokens, object-centric tokens, or latent embedding tokens, resulting in a token-heavy representation of the scene. For example, a high-resolution frame may produce hundreds to thousands of tokens depending on tokenization granularity, and successive frames may rapidly accumulate token volume when processed over time. In dynamic environments, this token growth may be further amplified by multi-view inputs, overlapping fields of view, or dense scene content including multiple objects, textures, and environmental features. Accordingly, high-resolution video streams can impose substantial token budgets and computational load on downstream AI systems, including transformer-based models and other token-consuming processes, thereby motivating selective token retention, pruning, and persistence techniques as described herein.

In some embodiments, the Skeleton Token Set is generated from a single frame at an initial time step. For example, a first frame may be processed to identify and select tokens corresponding to an object, region, or environmental condition, and the selected subset may be designated as the Skeleton Token Set for subsequent temporal persistence. In other embodiments, the system may utilize a buffer of multiple frames, such as two or more temporally adjacent frames, to determine the Skeleton Token Set. For example, information derived from motion cues, temporal consistency, trajectory estimation, occlusion patterns, or cross-frame correspondence may be used to refine selection of tokens, adjust persistence priority, or improve robustness of the resulting representation. In still further embodiments, an initial Skeleton Token Set may be generated from a single frame and subsequently updated, confirmed, or refined using additional frames as they become available. Thus, Skeleton Token Set formation may be based on single-frame analysis, multi-frame analysis, or a hybrid approach combining both.

### B. Temporal Lock and Persistence Interval

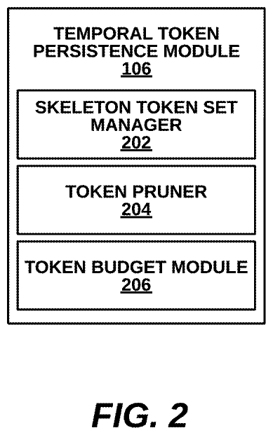

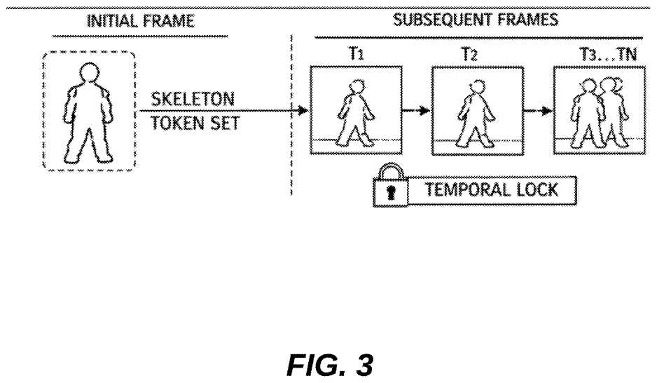

FIG. 2 is a detail of the temporal token persistence module 106, including a skeleton token set manager 202, a token pruner 204, and a token budget module 206. Furthermore, FIG. 3 illustrates the Skeleton Token Set in operation across several visual frames.

After generation, the Skeleton Token Set is assigned a temporal persistence state. In one embodiment, the persistence state comprises a temporal lock that protects corresponding tokens for a temporal interval spanning multiple subsequent frames. The interval may be fixed, such as 30 or 60 frames, or adaptive based on scene risk, predicted re-emergence, route complexity, policy configuration, or planner feedback.

Unlike ordinary frame-local pruning systems, the disclosed system does not require the protected tokens to re-earn retention in each subsequent frame based solely on instantaneous salience. Instead, persistence is maintained over time based on the prior designation of the Skeleton Token Set and any applicable update or release conditions.

In some embodiments, identification, formation, updating, or correspondence of a Skeleton Token Set may be assisted by one or more perception outputs, including object recognition, object detection, instance segmentation, semantic segmentation, keypoint detection, pose estimation, articulated-body estimation, tracking, trajectory prediction, or scene-understanding outputs. For example, object recognition may help identify tokens associated with a pedestrian, cyclist, vehicle, animal, machine, or other decision-relevant entity, while pose estimation or keypoint estimation may help define a sparse structural subset corresponding to an articulated object or vulnerable road user. However, the disclosed techniques do not require explicit object labels, pose outputs, or frame-level detections. In other embodiments, the Skeleton Token Set is selected, maintained, refreshed, or released based on token-space structure, latent similarity, spatial continuity, planner relevance, hazard scoring, occlusion state, motion history, world-model state, policy rules, or learned persistence scoring independent of explicit object recognition or pose estimation. Thus, object recognition and pose estimation may provide optional supporting signals for persistence decisions without limiting the Skeleton Token Set to a conventional detection box, segmentation mask, or anatomical pose representation.

In some embodiments, token selection, persistence scoring, or temporal-lock assignment may further depend on object-importance cues intentionally embedded in the physical environment or received from non-visual subsystems. For example, a sign, marker, beacon, or physical warning indicator may include visual features selected to increase detectability, salience, or machine-readability by a computer-vision system, such as high-contrast color patterns, distinctive geometric borders, reflective materials, fiducial patterns, encoded symbols, flashing regions, machine-optimized iconography, or other aesthetics configured to attract attention of an autonomous perception stack. By way of example, a speed limit sign, school-zone sign, construction warning sign, hazardous-condition sign, low-clearance sign, spill warning sign, emergency marker, or restricted-area sign may include such features so that corresponding visual tokens are more likely to be selected, assigned elevated importance, or persisted as part of a Skeleton Token Set.

In some embodiments, the same or similar physical warning source may additionally or alternatively transmit a wireless signal, such as by radio, short-range communication, vehicle-to-everything communication, Bluetooth, Wi-Fi, RFID, ultra-wideband, or another signaling mechanism, to an autonomous vehicle, robot, drone, or safety system. Such transmitted information may identify a hazard class, rule state, speed restriction, temporary condition, or location-specific warning and may increase persistence priority for associated tokens or may itself generate a persistent representation even before strong visual confirmation is obtained.

In other embodiments, persistence decisions are also informed by non-visual data sources internal or external to the physical AI platform. Such sources may include vehicle state signals, robot telemetry, safety subsystems, audio processors, inertial sensors, pressure sensors, thermal sensors, speedometers, wheel-speed sensors, tire-pressure gauges, brake-state sensors, proximity sensors, vibration sensors, microphones, siren detectors, impact detectors, operator alerts, networked safety broadcasts, or other sensory systems. For example, a speedometer or wheel-speed signal indicating elevated speed may increase importance assigned to speed-limit signage, roadway hazards, or stopping-distance-relevant obstacles; a tire-pressure warning may elevate persistence of road-surface anomalies, debris, or pull-over zones; and an audio processor detecting a siren, horn, alarm, spoken warning, machinery alert, or glass break may increase persistence of visually corresponding objects, directions, or regions even when direct line-of-sight visibility is partial or temporarily degraded. Thus, token persistence may be influenced not only by instantaneous visual salience, but also by cross-sensory warning signals and machine-readable environmental cues that indicate that a particular object, region, rule, or condition should remain available to downstream perception, planning, and control.

The Skeleton Token Set can be stored in a persistent token memory configured to retain token representations across a plurality of frames. The persistent token memory is distinct from a transient frame-level token buffer and is accessible by downstream modules including a planner or controller. The stored Skeleton Token Set may include token embeddings, spatial descriptors, object associations, and persistence metadata including temporal lock parameters and update conditions. In operation, tokens stored in the persistent token memory are selectively exempted from pruning operations and are reintroduced into subsequent frame processing without requiring regeneration from incoming visual data.

### C. Pruning Bypass

At later time steps, the system continues to process new frames and apply a token pruning algorithm configured to remove lower-priority or redundant tokens under a token budget. However, one or more tokens corresponding to the Skeleton Token Set are exempted from ordinary pruning rules during the temporal interval. Correspondence may be established by any suitable mechanism, including spatial overlap, reprojection, object association, tracking linkage, trajectory consistency, latent similarity, semantic correspondence, or cross-frame mapping. Thus, even if the corresponding object becomes low-motion, partially hidden, background-blended, or temporarily static, the protected representation remains available to the downstream embodied AI system.

### D. Budgeted Persistence

In some embodiments, the token budget module 206 enforces one or more budgets governing retention, persistence, update, and downstream consumption of visual tokens over time. The budget need not be limited to a single per-frame token count. Instead, the system may apply a frame budget, a multi-frame window budget, a downstream model budget, a processing-time budget, a memory budget, a bandwidth budget, an energy budget, or a monetary budget associated with AI inference. A frame budget may limit the number of tokens retained, protected, or forwarded from an individual frame. A window budget may limit the aggregate quantity of tokens retained across a rolling sequence of multiple frames, such as 8, 16, 32, 60, or another number of frames, thereby preventing persistent accumulation from saturating memory or context capacity over time. A downstream model budget may correspond to the token capacity, context-window allocation, KV-cache allocation, or other processing constraints of a multimodal transformer, vision-language model, Llama-family model, planner, world model, or other AI subsystem that consumes visual tokens. A monetary budget may reflect a cost ceiling for cloud-based or metered inference, such as when tokenized visual inputs are sent to a remote AI service with usage-based pricing. A time budget may reflect a latency target, deadline, or control-cycle requirement, such as a requirement that perception and planning complete within a bounded interval for safe operation.

In some embodiments, the system allocates the applicable budget between ephemeral tokens and persistent tokens. For example, a first portion of the available budget may be used for frame-local tokens representing newly observed scene content, while a second reserved portion is dedicated to Skeleton Token Sets or other protected persistent representations. The reserved portion may be fixed or dynamically adjustable. In this manner, the system can maintain bounded compute, bounded latency, bounded model load, or bounded inference cost while still preserving temporal continuity for objects, regions, or environmental conditions that remain relevant across multiple frames.

The token budget module 206 may further support multiple budget modes corresponding to different operating conditions. In a standard mode, such as normal driving, routine humanoid navigation, ordinary robot movement, or nominal drone flight, the system may apply a first budget profile that emphasizes efficiency, reduced compute cost, and controlled token usage. In a critical mode, the system may apply a second, different budget profile in response to elevated operational risk. Critical mode may be triggered, for example, by high vehicle speed, aggressive maneuvers, detection of a pedestrian or vulnerable road user, hazardous terrain, poor weather, low visibility, slippery surfaces, dense clutter, unexpected motion, near-collision conditions, dangerous factory-floor activity, or other dangerous environmental conditions. In critical mode, the system may increase the persistent-token reserve, increase the total token budget, extend persistence intervals, reduce pruning aggressiveness, relax cost constraints, or prioritize decision-relevant hazard representations over ordinary efficiency targets.

In some embodiments, the token budget module 206 monitors one or more error, risk, or uncertainty thresholds to determine whether ordinary budget enforcement remains appropriate. For example, the system may evaluate tracking instability, prediction divergence, perception uncertainty, planner disagreement, hazard score, localization uncertainty, sensor degradation, or another confidence metric. If a threshold is reached, exceeded, or otherwise satisfied, the system may temporarily suspend or override one or more token budgets and revert to fuller video processing. In such a fallback state, pruning may be reduced, disabled, or bypassed so that a denser or substantially complete set of frame tokens is processed for a temporary interval. This temporary return to fuller video processing may continue until the error condition, uncertainty state, or elevated danger condition subsides, after which the system may restore the prior budget mode or transition to another applicable budget profile. Thus, the disclosed system may operate not only with bounded token persistence, but also with adaptive and safety-aware budget control that selectively trades efficiency for robustness when warranted.

If token pressure increases while budget enforcement remains active, the system may compress persistent token sets rather than immediately deleting them. For instance, an original persistent set may be reduced to a smaller proxy representation, anchor-token subset, latent summary, or compressed structural form while still preserving object permanence, hazard awareness, or environmental continuity. Compression may be performed differently depending on the active budget mode, such that a standard mode uses more aggressive compression and a critical mode preserves a richer persistent representation.

In still other embodiments, a local token budget is configured to enable efficient inference on edge devices operating under local processing constraints, with reduced or selective reliance on remote cloud or data center resources. For example, an autonomous vehicle, humanoid robot, drone, or other embodied system may include onboard compute hardware with limited processing capacity, memory, power availability, thermal envelope, or latency tolerance. By enforcing a token budget that limits the number and persistence of visual tokens processed at each frame and across multiple frames, the system can maintain real-time operation within such local constraints. In this manner, the system may perform perception, tracking, planning, and control tasks substantially on-device without requiring continuous transmission of high-resolution video or dense token streams to a remote service. On the other hand, when the local token budget is not met, video frames are remotely inferenced at the data center, as a fallback.

In some embodiments, error rates govern token pruning. For example, a first token budget is applied between ephemeral tokens and persistent tokens in a standard token persistence mode. The system may reduce token usage by transmitting compact persistent representations, summaries, or selectively pruned token subsets, thereby reducing bandwidth usage and inference cost. However, if error rates breach a predetermined threshold, a second token budget can be applied that discontinues full pruning, and maintains more persistent tokens. Essentially, as a number of persistent tokens drops, while maintaining an acceptable error rate, a token budget can be maintained to stay within the capabilities of edge inferencing. On the other hand, as a number of persistent tokens increases, an amount of pruning drops, and a token budget may exceed capabilities of edge inferencing. In this case, data center inferencing is required.

In another case, elevated risk conditions, uncertainty thresholds, or critical operating modes, can trigger increase token budgets. In still further embodiments, the system may operate in a hybrid mode in which edge inference handles time-critical decisions using budget-constrained tokens, while cloud-based systems process supplementary data for longer-horizon reasoning, model updates, or retrospective analysis. Thus, the token budget serves not only as a local compute control mechanism, but also as a coordination mechanism between edge and cloud inference pipelines.

### E. Update, Decay, and Release

Persistent representations may be updated as new observations arrive. If later-frame tokens more accurately represent the same object, region, or environmental condition, the Skeleton Token Set may be refreshed or refined. Release conditions may include expiration of the temporal interval, affirmative absence determination, reduced risk score, planner determination of irrelevance, departure from a monitored region, replacement by a newer persistent representation, or budget-driven eviction of the lowest-priority persistent state. In some embodiments, decay is gradual, such that a full Skeleton Token Set transitions to a compressed representation before final release.

In operation, the token budget is consumed not merely by storage of tokens, but by downstream computational paths that ingest tokens as input sequence elements for machine learning inference. For example, a vision tokenizer or vision-language encoder may convert each incoming video frame into a set of visual tokens, and those visual tokens may then be passed to a transformer-based model, such as a Llama-family model or another large language model 150 adapted for multimodal input. In such a pipeline, each retained visual token occupies part of the model's effective context window and participates in attention computation, key-value cache generation, hidden-state propagation, and downstream decoding. As additional video frames arrive over time, newly generated tokens may be appended, merged, refreshed, or otherwise introduced into the inference stream, thereby increasing sequence length and corresponding compute and memory cost. Thus, token consumption is not limited to an abstract accounting limit, but directly affects latency, bandwidth, cache occupancy, and inference expense in the downstream AI stack.

In one example data path, a current frame is tokenized into patch tokens, object-centric tokens, region tokens, or latent embedding tokens, and a selected subset of those tokens is supplied to a multimodal interface layer that maps the visual embeddings into a token sequence consumable by a Llama-based transformer. The transformer then processes the sequence autoregressively or semi-autoregressively together with prompt tokens, state tokens, map tokens, planner tokens, or prior-frame memory tokens. Each retained visual token therefore consumes sequence capacity and contributes to attention operations against other tokens in the context. Because transformer attention cost grows with sequence length, unnecessary retention of low-value frame tokens can materially increase computational burden across repeated frame updates. In video or embodied inference settings, this burden may accumulate frame after frame, such that a system processing thirty or sixty frames over a short interval may repeatedly consume token budget on transient background content unless more persistent and selective retention logic is applied.

The same token budget may also be consumed by non-large language model AI processes. For example, retained tokens may be ingested by an object tracker, trajectory predictor, occupancy forecaster, scene graph generator, world model, policy model, safety monitor, or motion planner. In some implementations, the same token representations are reused across multiple downstream modules, while in other implementations the tokens are transformed into derivative embeddings, summaries, graph nodes, or planner features. Even where the downstream consumer is not itself an autoregressive language model, retained tokens still consume compute resources because each additional token may trigger feature extraction, association, temporal fusion, cross-attention, memory updates, or risk scoring. Accordingly, the token budget may be understood as a shared inference resource budget spanning one or more AI subsystems rather than only a front-end visual pruning threshold.

Using Llama as a concrete example, a multimodal system may receive visual embeddings corresponding to successive video frames and project those embeddings into the hidden-state space expected by a Llama decoder. The projected embeddings may be inserted into the prompt context as visual token blocks, interleaved with textual instructions, planner state descriptors, or control prompts. Llama then consumes those token blocks through stacked self-attention layers and feed-forward layers, while storing corresponding key and value tensors in cache memory for continuing inference. When later video frames arrive, additional visual tokens may be appended or old tokens may be retained to preserve temporal continuity. If too many raw frame tokens are retained, the context window and KV cache can become saturated with repetitive or low-priority content, reducing room for future observations and increasing inference cost. The disclosed Skeleton Token Set reduces this burden by preserving only a compact persistent subset for objects, regions, or conditions that remain decision-relevant over time, while allowing less relevant transient tokens to be pruned.

Stated differently, the invention improves the efficiency of an AI data path in which video-derived tokens are repeatedly consumed over time by a transformer or other inference engine. Rather than requiring every frame to reestablish the full representation of an intermittently visible object, the system stores a compact persistent representation in memory and selectively reuses or protects that representation across subsequent frame intervals. This reduces repeated token spending on reacquisition of the same entity, preserves context capacity for newly emerging hazards or scene changes, and improves the quality of downstream reasoning by maintaining continuity even when instantaneous salience drops due to occlusion, low motion, background blending, or temporary absence from direct view.

### F. Example Use Cases

In one example, an autonomous vehicle observes a child near a parked car. At an initial frame, the system extracts a Skeleton Token Set corresponding to the child and assigns a temporal lock, as shown in FIG. 3, for a sequence of subsequent frames. The child then becomes partially occluded and temporarily static. A frame-local pruner might otherwise delete those tokens due to low instantaneous attention score. Under the present techniques, corresponding tokens remain protected from deletion, enabling the planner to preserve caution in path planning, braking, or speed selection until the hazard is resolved or the persistence interval expires.

In additional example use cases, the disclosed techniques may be applied in other physical AI systems beyond autonomous vehicles. For example, a humanoid robot navigating a home, warehouse, hospital, or industrial site may retain a Skeleton Token Set for a stair edge, a partially occluded person, a handrail, a tool, a spill, or another environmental hazard or interaction-relevant feature, thereby preserving locomotion or manipulation awareness across subsequent frames even when the feature becomes partially hidden or visually de-emphasized. On a factory floor, multiple autonomous robots may independently or cooperatively maintain persistent token representations for human workers, forklifts, shared work zones, moving equipment, pallet locations, loading areas, restricted regions, or transient hazards so that planning and collision avoidance remain informed despite intermittent occlusion, motion blur, or clutter. In aerial embodiments, a drone or other unmanned vehicle may preserve Skeleton Token Sets corresponding to power lines, tree branches, landing zones, rooftop edges, nearby aircraft, birds, towers, smoke, dust, or other navigation-relevant conditions across changing viewpoints and temporary visual degradation. More generally, the same persistence techniques may be used in other physical AI platforms, including mobile robots, delivery robots, agricultural robots, security robots, robotic manipulators, marine vehicles, and mixed human-machine environments, where compact persistent token representations improve continuity, safety, and decision quality under bounded token budgets.

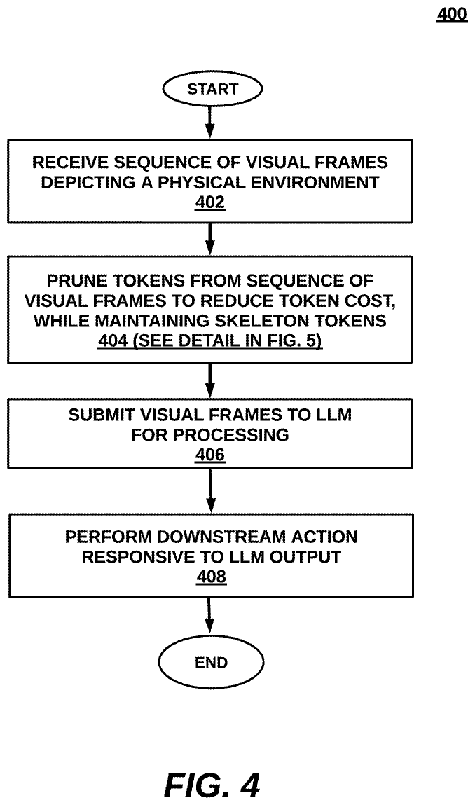

### II. Methods for Temporal-Aware Token Persistence (FIGS. 4-7)

FIG. 4 illustrates a high-level method 400 for performing temporal-aware token persistence with protected bypass of a pruning algorithm. As shown in the flow diagram, the method begins at step 402, where a sequence of visual frames depicting a physical environment is received. The frames may be captured by one or more sensors associated with an embodied AI system.

At step 404, tokens are generated and pruned from the sequence of visual frames to reduce token cost while maintaining one or more Skeleton Token Sets. In particular, a token pruning algorithm is applied to remove lower-priority or redundant tokens, while exempting tokens corresponding to persistent Skeleton Token Sets from pruning. The exemption may be enforced irrespective of instantaneous salience metrics, thereby ensuring temporal continuity of decision-relevant entities.

At step 406, the resulting token set, including both pruned tokens and retained Skeleton Token Sets, is submitted to a downstream AI model, such as a multimodal transformer or large language model, for processing. At step 408, one or more downstream actions are performed responsive to the model output, including planning, control, navigation, or safety actions. The method then terminates or repeats for subsequent frame sequences.

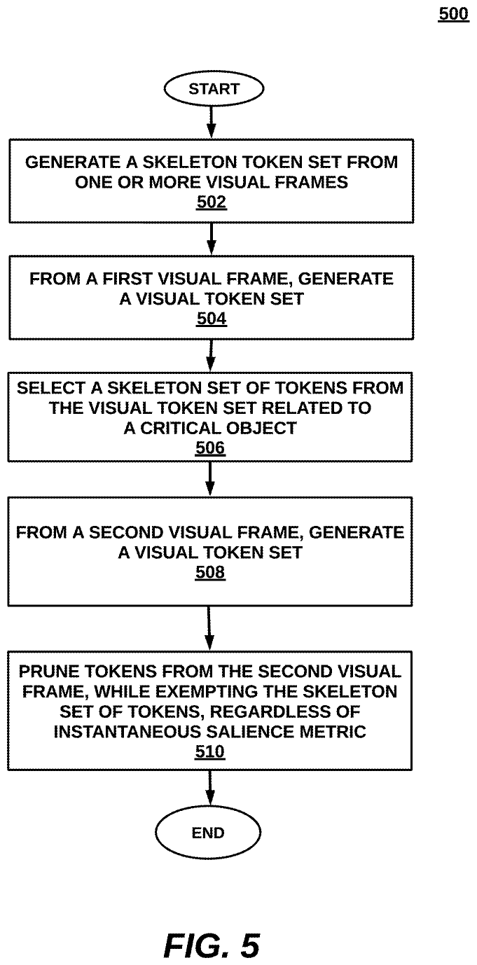

FIG. 5 illustrates a more detailed method 500 for generating and maintaining Skeleton Token Sets during token pruning. At step 502, a Skeleton Token Set is generated from one or more visual frames.

At step 504, a first visual frame is processed to generate a plurality of visual tokens. At step 506, a subset of the visual tokens is selected to form a Skeleton Token Set corresponding to a critical object, region, or environmental condition. Selection may be based on hazard relevance, trajectory relevance, occlusion risk, or other persistence criteria.

At step 508, a second visual frame is processed to generate a second plurality of visual tokens. At step 510, a token pruning algorithm is applied to the second visual frame to reduce token cost. However, tokens corresponding to the Skeleton Token Set are exempted from pruning regardless of an instantaneous salience metric. Correspondence between tokens may be determined using spatial overlap, tracking association, reprojection, latent similarity, or other cross-frame mapping techniques.

In this manner, FIG. 5 illustrates how the system enforces protected persistence across frames by selectively bypassing pruning operations for designated Skeleton Token Sets.

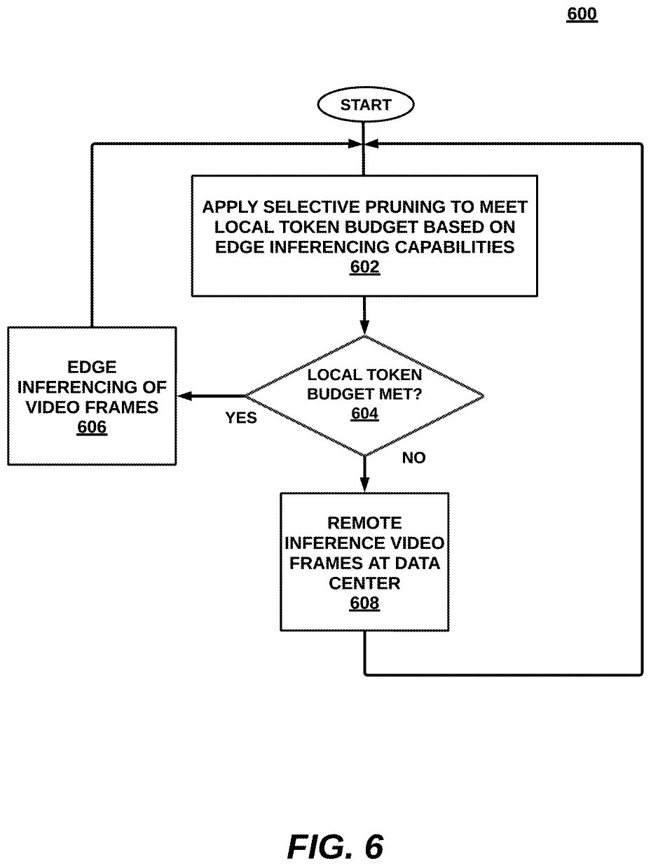

FIG. 6 illustrates a method 600 for managing token budgets across edge and data center inference environments. At step 602, selective token pruning is applied to meet a local token budget associated with edge inferencing capabilities.

At decision step 604, the system determines whether the local token budget is satisfied. If the local token budget is met, the system proceeds to step 606, where video frames are processed locally using edge inference.

If the local token budget is not met, the system proceeds to step 608, where video frames are transmitted for remote inference at a data center. In some embodiments, the remote inference may utilize larger models, expanded token budgets, or additional computational resources.

In various embodiments, Skeleton Token Sets are maintained across both edge and remote inference paths, ensuring continuity of persistent representations regardless of processing location. Thus, FIG. 6 illustrates adaptive allocation of inference resources based on token budget constraints while preserving persistent tokens.

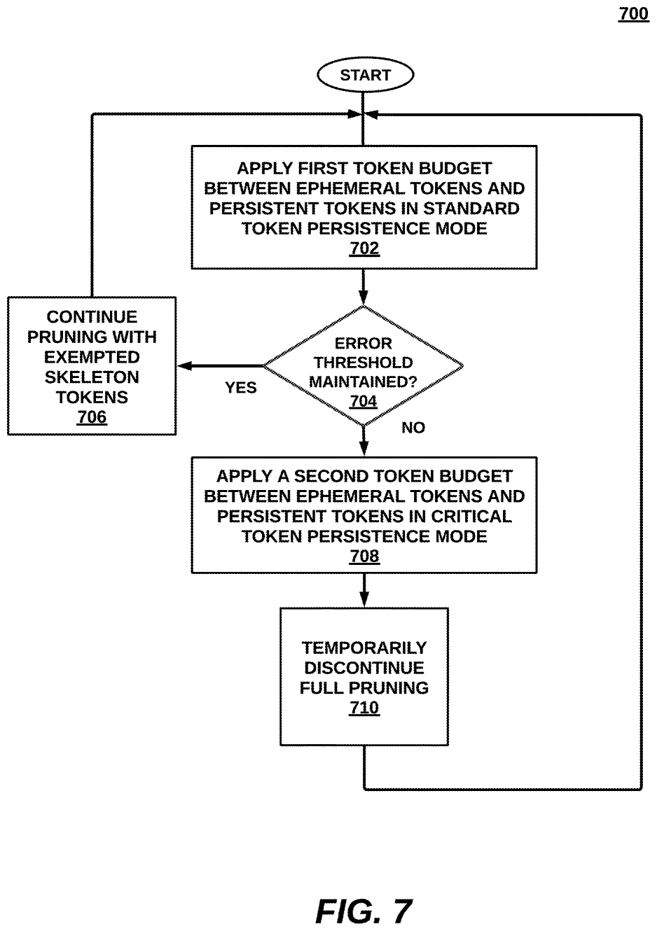

FIG. 7 illustrates a method 700 for operating under multiple token budget modes, including a standard mode and a critical mode. At step 702, a first token budget is applied between ephemeral tokens and persistent tokens in a standard token persistence mode.

At decision step 704, the system determines whether an error threshold, risk threshold, or uncertainty threshold is maintained. If the threshold is maintained, the system proceeds to step 706, where pruning continues while exempting Skeleton Token Sets from pruning.

If the threshold is not maintained (e.g., risk increases or uncertainty rises), the system transitions to step 708, where a second token budget is applied in a critical token persistence mode. In this mode, the allocation of tokens may favor persistent tokens, increase overall token budget, or reduce pruning aggressiveness.

At step 710, the system may temporarily discontinue or reduce full pruning, thereby increasing the number of retained tokens to improve robustness. This fallback state may persist until the error, risk, or uncertainty condition is resolved, after which the system may return to the standard mode.

Accordingly, FIG. 7 illustrates dynamic adaptation of token persistence and pruning behavior in response to operational conditions, enabling the system to trade efficiency for safety and robustness when needed.

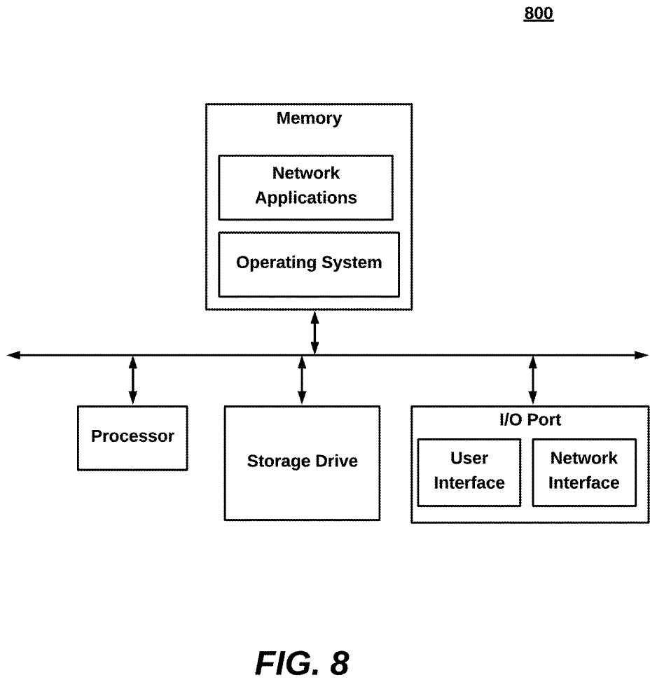

### III. Computing Device for Temporal-Aware Token Persistence (FIG. 8)

FIG. 8 illustrates an example computing device 800 for implementing the systems and methods described herein. The computing device 800 may include a processor, memory, storage drive, input/output (I/O) interface, and network interface.

The processor can be an AI acceleration processor, a graphical processing unit (GPU), a central processing unit (CPU), an application-specific integrated circuit (ASIC), a field programmable gate array (FPGA), and the like. Some embodiment have several processors that can be of the same type (e.g., an array for GPUs) or mixed types (e.g., a CPU and a GPU). The processor may execute instructions stored in memory to perform tokenization, Skeleton Token Set generation, temporal persistence management, token pruning, and downstream inference operations. The memory may store an operating system, application programs, and persistent token data, including Skeleton Token Sets and associated metadata such as temporal lock parameters.

The storage drive may provide non-volatile storage for program code, datasets, and model parameters. The I/O interface may include user interface components and communication ports for interacting with external devices, sensors, or actuators. The network interface may enable communication with remote systems, including cloud-based inference services or distributed AI platforms.

In some embodiments, the computing device 800 may be deployed as part of an edge device, such as an autonomous vehicle controller, robotic system, drone, or industrial AI system. In other embodiments, the computing device 800 may be part of a data center or cloud infrastructure that performs remote inference or supports distributed token persistence.

The components of the computing device 800 may be interconnected via one or more buses or communication pathways, and may be implemented in hardware, software, firmware, or combinations thereof. The computing device 800 may operate in conjunction with the temporal token persistence module and persistent token memory described herein to enable efficient and robust token management across time.

### IV. Generalities of Description

This description of the invention has been presented for the purposes of illustration and description. It is not intended to be exhaustive or to limit the invention to the precise form described, and one of ordinary skill in the art will recognize many modifications and variations are possible in light of the teaching above. The embodiments were chosen and described in order to best explain the principles of the invention and its practical applications, in a concise manner. This description will enable others skilled in the art to best utilize and practice the invention in various embodiments and with various modifications as are suited to a particular use.

The scope of the invention is defined by the following claims.

I claim:

1. A computer-implemented method for processing visual data in a physical artificial intelligence (AI) device, the method comprising:
receiving a sequence of visual frames depicting a physical environment of the physical AI;
processing a first frame to generate a plurality of visual tokens;
selecting, from the plurality of visual tokens, a subset associated with a physical object, region, or environmental condition;
generating a skeleton token set from the subset, the skeleton token set comprising a reduced persistent representation of the physical object, region, or environmental condition;
assigning a temporal lock to the skeleton token set for a temporal interval spanning multiple subsequent frames;
processing a later frame with a token pruning algorithm configured to remove lower-priority tokens under a token budget; and
exempting one or more tokens corresponding to the skeleton token set from the token pruning algorithm during the temporal interval irrespective of an instantaneous salience metric, thereby retaining information associated with the physical object, region, or environmental condition for downstream perception, prediction, planning, or control.

2. The method of claim 1, further comprising:
submitting, to a large language model (LLM), token-reduced visual data generated from the sequence of visual frames after processing by the token pruning algorithm, wherein the token-reduced visual data includes fewer visual tokens than corresponding unpruned visual data generated from the sequence of visual frames.

3. The method of claim 2, wherein submission of the token-reduced visual data reduces an inferencing cost of the LLM relative to submission of the corresponding unpruned visual data.

4. The method of claim 2, further comprising receiving an inference output from the LLM and causing an actuator of the physical AI device to perform an action based on the inference output.

5. The method of claim 4, wherein the actuator is a vehicle actuator, and wherein the action comprises one or more of braking, steering, accelerating, decelerating, lane-position adjustment, path selection, or speed adjustment.

6. The method of claim 4, wherein the actuator is a humanoid robot actuator, and wherein the action comprises one or more of locomotion adjustment, balance correction, obstacle avoidance, grasp execution, arm movement, hand movement, tool manipulation, or body-position adjustment.

7. The method of claim 1, wherein the physical object comprises a pedestrian, child, cyclist, worker, animal, vehicle, robot, or forklift.

8. The method of claim 1, wherein the physical object comprises a human, body part, hand, tool, furniture, appliance, door, handle, stair, railing, surface, obstacle, or manipulable object within an environment of a humanoid robot.

9. The method of claim 1, wherein the physical object becomes partially occluded during the temporal interval.

10. The method of claim 1, wherein the physical object becomes temporarily static during the temporal interval, causing a drop in the instantaneous salience metric.

11. The method of claim 1, wherein the temporal interval spans at least 30 frames.

12. The method of claim 1, wherein the one or more tokens corresponding to the skeleton token set are identified using spatial overlap, reprojection, object association, tracking linkage, trajectory consistency, semantic mapping, or latent-token correspondence.

13. The method of claim 1, wherein the token budget comprises a first portion for non-persistent tokens and a second reserved portion for one or more skeleton token sets.

14. The method of claim 1, further comprising updating the skeleton token set using one or more tokens from one or more additional frames corresponding to the physical object, region, or environmental condition.

15. The method of claim 1, wherein generating the skeleton token set comprises compressing a larger source token group into a reduced persistent representation.

16. The method of claim 1, wherein assigning the temporal lock is based on at least one of semantic class, vulnerability class, hazard score, path-intersection score, occlusion risk, motion history, planner feedback, or uncertainty.

17. The method of claim 1, further comprising releasing the skeleton token set in response to expiration of the temporal interval or satisfaction of a release condition.

18. The method of claim 16, wherein the release condition comprises a planner determination of irrelevance, a confidence decay threshold, an affirmative absence determination, or a reduction in hazard relevance.

19. The method of claim 1, wherein the token pruning algorithm utilizes an attention score, reconstruction score, compression score, motion score, or learned token importance score.

20. The method of claim 1, wherein the temporal lock enforces persistence independent of frame-level token importance evaluation.

21. The method of claim 1, further comprising:
allocating a token budget between ephemeral tokens and persistent tokens, wherein a reserved portion of the token budget is dedicated to one or more skeleton token sets.

22. A system comprising:
one or more sensors configured to capture sensor data representing a physical environment;
one or more processors; and
memory storing instructions that, when executed by the one or more processors, cause the system to:
generate tokenized representations from the sensor data over a sequence of time steps;
select a subset of tokens associated with a physical object, region, or environmental condition;
generate a skeleton token set comprising a reduced persistent representation of the physical object, region, or environmental condition;
assign a temporal lock to the skeleton token set; and
retain the skeleton token set across multiple subsequent time steps by exempting corresponding tokens from ordinary token pruning despite a reduction in instantaneous salience.

23. A non-transitory computer-readable medium storing instructions that, when executed by one or more processors, cause the one or more processors to perform operations comprising:
tokenizing visual data for a sequence of frames;
creating a skeleton token set associated with a physical object, region, or environmental condition;
assigning a temporal lock to the skeleton token set;
applying token pruning to later-frame tokens; and
bypassing token pruning for one or more tokens associated with the skeleton token set irrespective of a current-frame salience metric.
